(19) United States
(12) Patent Application Publication
(10) Pub. No.: US 2014/0113673 A1
(43) Pub. Date: Apr. 24, 2014

(54) METHOD AND DEVICE WITH A PUSH TO TALK FEATURE

(71) Applicant: MOTOROLA MOBILITY LLC, Libertyville, IL (US)

(72) Inventors: Wayne W. Ballantyne, Coconut Creek, FL (US); Jason A. Knopsnyder, Crystal Lake, IL (US); Bach L. Nguyen, Lauderhill, FL (US); Lisajane M. Romer, Delray Beach, FL (US)

(73) Assignee: MOTOROLA MOBILITY LLC, Libertyville, IL (US)

(21) Appl. No.: 13/656,853

(22) Filed: Oct. 22, 2012

(51) Int. Cl. H04W 4/10

(52) U.S. Cl. CPC H04W 4/10
USPC 455/518

(57) ABSTRACT

A wireless communication method with a push to talk feature (300) and PTT module (400), are disclosed. The method (300) can include: providing (310) a wireless communication device including a receptacle for a function not necessarily related to PTT; detecting (320) a trigger signal that a push to talk accessory has been connected to the receptacle; identifying (330) a signature of the push to talk accessory; and configuring (340) the wireless communication device with push to talk functionality, based on the identified signature of the push to talk accessory. Advantageously, the method (300) and module (400) provide a simple and robust way of connecting and operating a wireless communication device and PTT accessory.

### BACKGROUND

1. Field

The present disclosure relates to a method and device with a push to talk feature.

2. Introduction

Push to talk (PTT) applications, such as those based on PTT over Cellular protocol (POC), are often designed to work on a multiplicity of devices, including smart phones, tablets, or feature phones. These devices often do not have a dedicated PTT Button. For such devices without a PTT button, these PTT applications allow a user to assign an existing button to act as a PTT button during the PTT session. However, this takes away the normal function of the button. Furthermore, the location of a “multiplexed” button may not be on the left side of the device, or in a location conducive to PTT use. The conventional or preferred location of a PTT button on conventional two way radios, such as iDEN PTT devices and Qchat PTT devices, is on the left side.

Another issue with existing PTT devices is that the built-in buttons are often a fixed size and color, and typically fail to stand out or catch a user's attention as to the location of the button, reflecting a poor industrial design for a user. Thus, there is no opportunity for personalization of the PTT button itself.

Thus, there is a need for an improved push to talk module that users desire.

There is a need for enhanced PTT that is ergonomically desired, customized and embraced by a user.

It would be considered an improvement in the art, if an improved push to talk module were developed and provided a solution to some of the above problems and challenges.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary communication system with a terminal showing potential locations for a PTT accessory.

FIG. 2 is an exemplary block diagram of a wireless communication device with PTT module according to one embodiment.

FIG. 3 is an exemplary block diagram of a method to interface a wireless communication device with a PTT module according to one embodiment.

FIG. 4 is an exemplary exploded view of a PTT module according to one embodiment.

FIG. 5 is an exemplary front and rear perspective view of a PTT module with two connectors according to one embodiment.

FIG. 6 is an exemplary front and rear perspective view of a PTT module with an illumination feature according to one embodiment.

FIG. 7 is an exemplary block diagram of a PTT accessory connected to a micro-USB port of a wireless communication device according to one embodiment.

### DETAILED DESCRIPTION

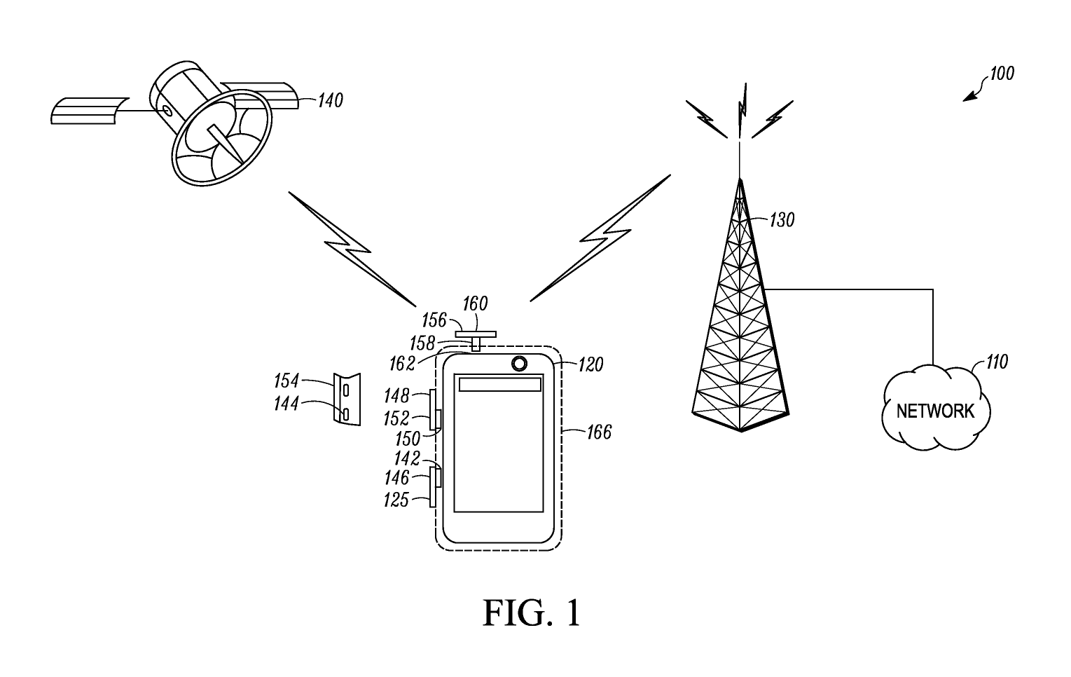

FIG. 1 is an exemplary block diagram of a system 100 according to one embodiment. The system 100 can include a network 110, a terminal 120, and a base station 130. The terminal 120 may be a wireless communication device, such as a wireless telephone, a wearable device, a cellular telephone, a personal digital assistant, a pager, a personal computer, a tablet, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can include a push to talk (PTT) accessory 125, for providing PTT functionality, as detailed more fully herein. The terminal 120 is shown being in communication with a global positioning system (GPS) 140 satellite, global navigation satellite system (GNSS) or the like, for position sensing and determination.

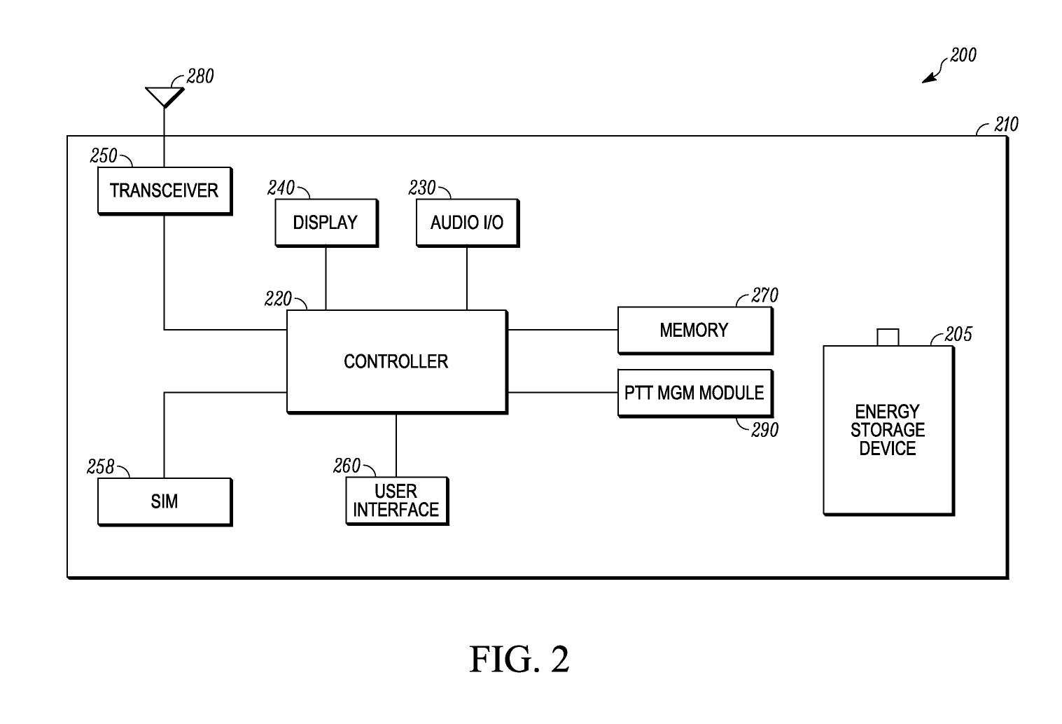

FIG. 2 is an exemplary block diagram of a wireless communication device 200 configured with an energy storage device, battery or module 205, such as in the terminal 120, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

As shown in FIG. 2, the wireless communication device 200 further includes a PTT management module (PTT module) 290, as described in more detail below.

In one embodiment, the PTT module 290 can reside within in the controller 220, can reside within the memory 270, can be an autonomous module, can be software, can be hardware, or can be in any other format useful for a module on a wireless communication device 200. Thus, a user can customize his or her device in any conventional way, such as by downloading, upgrading from a site, loading from a memory stick via a USB connection and the like.

The display 240 can be a liquid crystal display (LCD), a light emitting diode (LED) display, a plasma display, a touch screen display or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch screen or pad, a joystick, an additional display, or any other device useful for providing an interface between a user and an electronic device. The memory 270 may include a random access memory, a read only memory, an optical memory or any other memory that can be coupled to a wireless communication device.

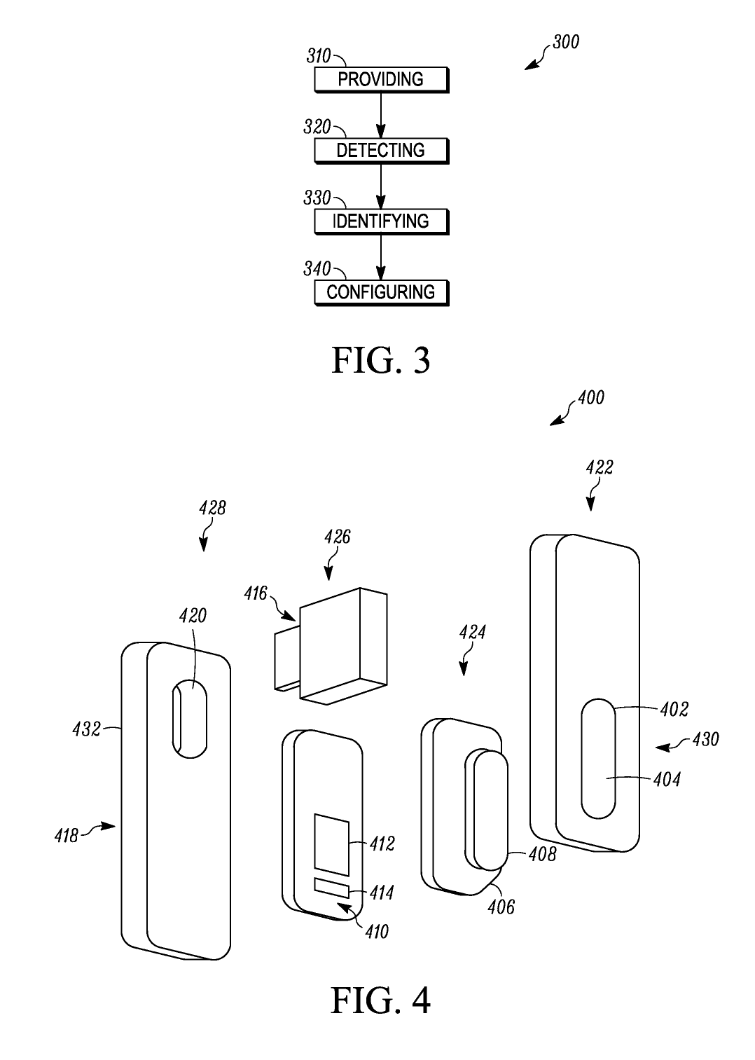

A block diagram of a wireless communication method with a push to talk feature 300, is shown in FIG. 3. In its simplest form, the method 300 can include: providing 310 a wireless communication device including a receptacle for a function not necessarily related to PTT; detecting 320 a trigger signal that a push to talk accessory has been connected to the receptacle; identifying 330 a signature of the push to talk accessory; and configuring 340 the wireless communication device with push to talk functionality, based on the identified signature of the push to talk accessory. Advantageously, the method provides a simply way of electrically connecting and operating a wireless communication device and PTT accessory, by using a unique signature.

The method further allows an external PTT accessory to be placed at a custom location in proximity to a receptacle location, such as the three different possible locations, as shown in FIG. 1, without detrimentally affecting the industrial design for a user. The method also contributes to allowing personalization of the location of the PTT accessory, with an enhanced ergonomic design, embraced by a user.

In one embodiment, as shown in FIG. 1, the PTT accessory 125 includes a USB connector or plug 142 and a button 146 and the receptacle is a USB port 144. In a second embodiment, a PTT accessory 148 includes a HDMI plug 150 and a button 152 and the receptacle is a HDMI port 154. Additionally, in a third embodiment, a PTT accessory 156 includes a headset connector 158 and a button 160 and the receptacle 162 is a headset jack receptacle. This provides enhanced versatility for a designer and user, as the device can be placed at various desired locations, in connection with a wireless communication device.

As shown in the figures, the push to talk accessory includes a button including an actuated mode when pressed and an un-actuated mode when not pressed. Typically this allows transmission of voice when actuated. This can provide push to talk functionality in a device not originally designed with push to talk functionality.

In one embodiment, a wireless communication device can provide indicia that it has PTT functionality, when the PTT button is pressed. For example, the indicia could be a display icon, an audible chirp, an LED turning on, or tactile feedback.

In another embodiment shown in FIGS. 1 and 2, the wireless communication device with a push to talk feature can include: a PTT accessory 125 including a connector 142 configured to be connected to a wireless communication device 200; and a wireless communication device 200 including: a housing 210 including a receptacle; a controller 230 coupled to the housing 210, the controller 230 configured to control the operations of a wireless communication device; and a PTT management module 290 configured to: detect a trigger signal that a push to talk accessory has been connected; identify a signature of a push to talk accessory; and configure the wireless communication device with push to talk functionality, based on the identified signature of the push to talk accessory.

Advantageously, this structure provides a simply way of electrically connecting, configuring and operating a wireless communication device and PTT accessory, by using a unique signature. The design also contributes to allowing personalization of the location of the PTT accessory, with an enhanced and desirable ergonomic design. As previously detailed, the push to talk accessory can include at least one of a USB connector, a HDMI connector and a headset connector and the receptacle can includes at least one of a USB port, a HDMI port and a headset jack receptacle, respectively, the receptacle being complementarily configured to be receive the connector. This allows versatility as to interconnection and placement of the PTT accessory.

In another embodiment, a wireless communication method with push to talk feature can include: providing a wireless communication device including a receptacle for attaching a PTT button; providing a PTT application with a configuration option; allowing the user to configure the application to respond to a PTT button attached to the receptacle; and configuring the wireless communication device with push to talk functionality using the attachable button, based on a configuration setting. In this embodiment, a PTT application can be loaded in PTT module 290, for example, and it can simply trust that the user has attached a PTT accessory 702, if set in a configuration menu.

The wireless communication device, in one arrangement, includes a user interface including a display providing indicia confirming that the wireless communication device has PTT functionality that is enabled. This allows a user to ascertain whether PTT functionality is enabled or not. In another embodiment, the PTT accessory includes indicia that push to talk functionality is enabled. This can be implemented with the use of an LED, for example, as shown in FIGS. 4-6.

As previously detailed, the PTT accessory includes a button including an actuated mode when pressed and an un-actuated mode when not pressed.

Referring to FIG. 4, an embodiment of a PTT module 400 is shown. The PTT module 400 can include: a housing 402 having an aperture 404; a button module 406 including a button 408 reachable through the aperture 404; a printed circuit 410 including a switch 412; a plug 416 connected to the printed circuit board 410; and a base 418 with a hole 420, the hole 420 configured to receive the plug 416 there through. Advantageously, this structure provides a miniature, robust and low profile accessory, which can be easily connected or disconnected to a wireless communication device.

In one arrangement, the housing 402 includes a first layer 422, the button module 406 a second layer 424, the printed circuit board 410 and plug 416 a third layer 426 and the base 418 a fourth layer 428, defining a multilayered structure. This structure provides a sandwiched and narrow profile, easily assembled and tested, with minimal dimensional requirements. Advantageously, a user desires a miniature accessory that adds minimal additional overall size to a device.

As shown in FIGS. 4 and 6, in one embodiment, the housing 402 defines an upper portion 430 and the base 418 a bottom portion 432, defining a narrow profile structure. This forms a narrow and durable exterior, to withstand a harsh user environment. The geometry is configured to be complementarily configured to be partially received and conformed to the exterior of a wireless communication device, for enhanced aesthetics, ergonomics and mechanical interconnection. 14. As shown in FIG. 4 the PTT module 400 can include an illumination feature, such as an LED being lighted through a transparent button 408 when the PTT button is pressed, if desired.

In one arrangement, the button module 406 or printed circuit board 410 can include a switch 412, in the form of a popple, and other electrical components 414, such as an LED and a timing component. Advantageously, an LED can indicate that the PTT module 400 is operable. For example, upon insertion with a wireless communication device, an LED can remain on for a predetermined time out, to indicate PTT functionality is operable and/or it can be activated only when the button 408 is depressed. As should be understood, other arrangements relating to lighting or indicia are possible. Also, this construction adds illumination and indicia with minimal power drain.

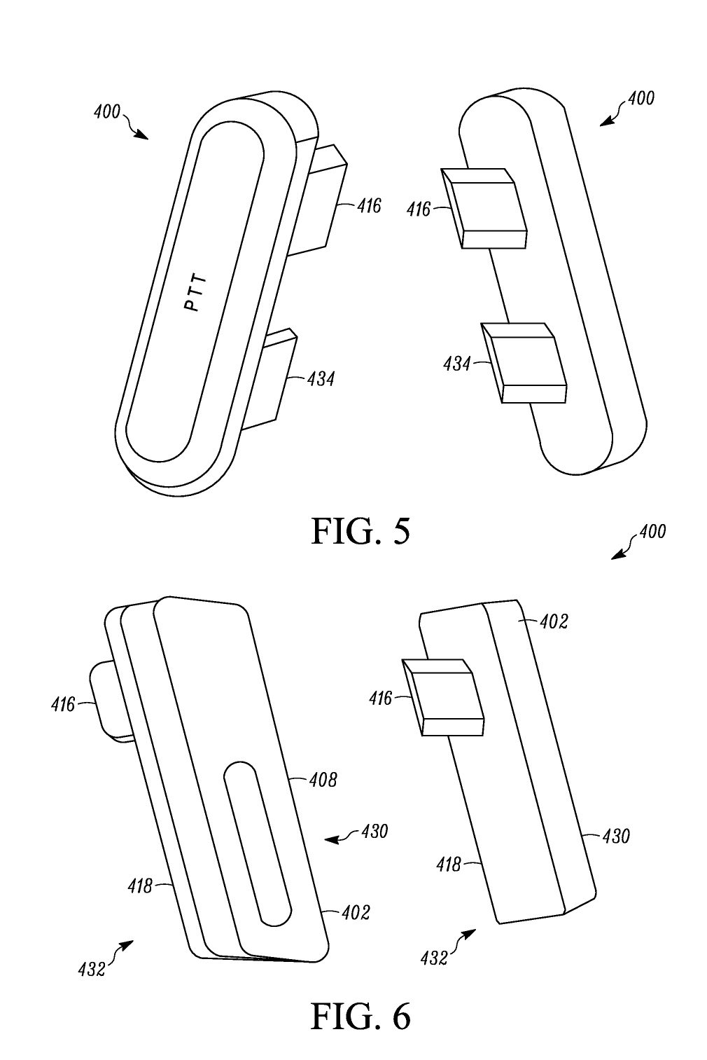

FIG. 5 is an exemplary front and rear perspective view of a PTT module with two connectors according to one embodiment. The PTT module 400 can include a second connector 434, in the form of a plug, for example Advantageously, a second connector 434 can provide enhanced anchoring to a wireless communication device. The PTT module can be illuminated, as previously detailed.

In another embodiment as shown in FIG. 1, the PTT accessory 125 can be integrated with a protective structure or case 166. For example, a case 166 can be configured to be at least partially around an outer periphery of a wireless communication device, and the PTT accessory 125 is integrated therein. In one embodiment, the protective structure can be a holster-like structure or the like. Advantageously, this provides improved anchoring and securing to a wireless communication device, for example. This can provide an enhanced connection between the PTT accessory 125 with a wireless communication device such that the two become an integrated structure.

In one embodiment, the PTT module 400 is passive, thus helping to conserve power.

In one embodiment, the PTT module 400 is integrated into an external accessory. For example, the external accessory can include a docking station, radio holster, charger with pass through, and the like.

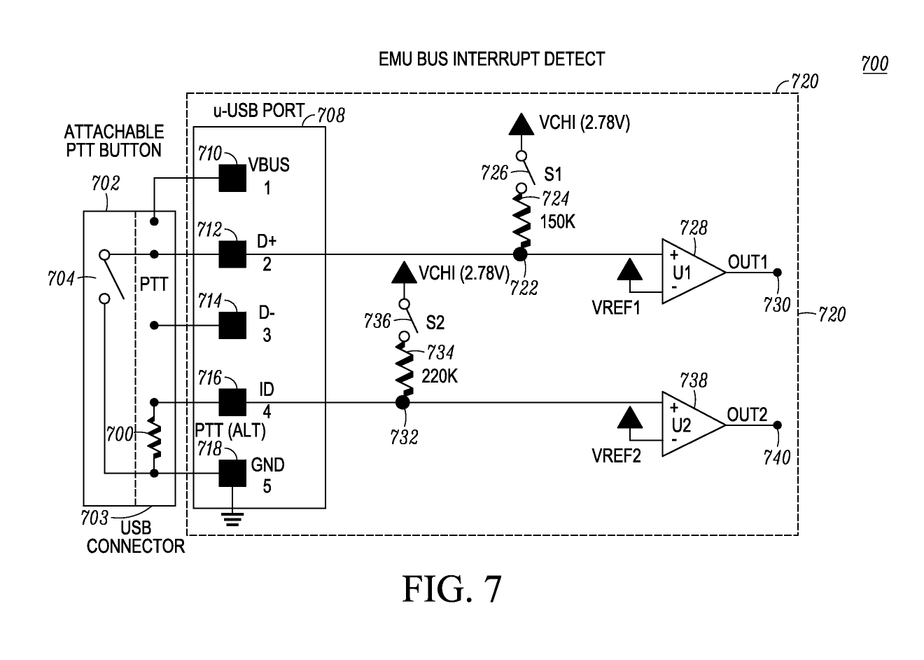

FIG. 7 is an exemplary block diagram of a PTT accessory 702 with a micro-USB plug 703 connected to a micro-USB port 708 of a wireless communication device 720. In this example, the wireless communication device is loaded with a PTT functionality program, which can be in the PTT management module 290.

The plug 703 of PTT accessory 702 is inserted into the USB port 708, a trigger signal that a PTT accessory 702 has been connected to the USB port 708 is detected, the PTT management module 290 identifies a signature of the PTT accessory 702, and the wireless communication device with push to talk functionality is configured, based on the identified signature of the PTT accessory.

The detection 320 and identification steps 330 can operate as follows. On the wireless communication device 720 USB port 708, an ID signal 716 will be pulled to about 2.78 v, at switch S2 736, through a resistor 734, such as a 220 k ohm resistor. On the PTT accessory 702 side, an ID signal can be pulled to ground through a resistor 706, such as a 440 k ohm resistor, when the PTT accessory 702 is attached. Upon initial insertion of the PTT accessory 702, the voltage at ID signal 716, is pulled below its initial voltage of 2.78 v. This voltage transition on the ID signal at node 732, can be detected using a comparator U2 738 with a VREF2 below the ID's resting voltage of 2.78v. The output of the comparator U2 738 at node 740 can be used as a detection interrupt to the wireless communication device's controller 220. Once interrupted, the wireless communication device's 720 controller 220 can execute an identification (330) software driver to determine if the attachable PTT button accessory 720 is present.

The identification of the PTT accessory 702 can be accomplished based on the following signal levels:

1) a VBUS 710 voltage of 0 volts;

2) a D+ 712 voltage can be ignored since the PTT accessory's button, or switch 704 may or may not be pressed during identification;

3) a D− 714 voltage is at its resting level of 0 v; and

4) a unique voltage on the ID signal 716. The unique voltage is generated by a voltage divider created by the attachment of the PTT accessory 702 to the wireless communication device 720.

Once the PTT accessory 702 has been identified as the attached accessory, configuration of the system can be accomplished by the following:

1) The presence of the PTT accessory 702 can be propagated to the software system. This includes a message from a software driver to an application layer. The application layer can choose to ignore the message, may choose to open a menu for the user to choose the PTT button behavior, or the application layer may choose to automatically map all subsequent attachable PTT button presses and releases to the systems PTT functionality.

2) The software driver will begin listening for a transition interrupt on the OUT1 signal, at node 730. A transition on this signal indicates that the PTT button or switch 704 has been pressed or released. The button is a normally open switch 704. When the switch 704 is open, the OUT1 voltage, at node 730, will be at its resting voltage of about 2.78 v. The software driver will identify this voltage level as a release. When the switch 704 is closed, the OUT1 voltage, at node 730, will be pulled to GND from 718. The software driver will identify this voltage level as a press, assuming proper debounce times are met.

3) The software driver will begin listening for a transition interrupt on the OUT2 signal, at node 740. While the PTT accessory 702 is present, a transition on this signal indicates the PTT accessory 702 may no longer be present. A re-identification can be needed to determine if the accessory has been removed.

Stated differently, when the PTT switch 704 is pressed, the Comparator U1 728 output at node 730 changes state (1 to 0), which generates an interrupt to the PTT application. A PTT request is sent to the PTT server, and if the receiving party is available, the WCD 720 will be signaled and a PTT chirp will be emitted on the WCD 720. After that, TX audio transmission commences, and RX audio stops. And, when the PTT button 704 is released the Comparator U1 728 output, at node 730, changes state (0 to 1), which generates an interrupt to the PTT application. A PTT dekey request is sent to the PTT server, and the TX audio transmission stops.

Alternatively, a PTT application can be loaded in PTT module 290, for example, and it can simply trust that the user has attached a PTT accessory 702, if set in a configuration menu. Thus, the detecting and identifying steps would not be required in this embodiment.

The devices 120 and 200 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure. In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method with push to talk feature, comprising:
providing a wireless communication device including a receptacle;
detecting a trigger signal that a push to talk accessory has been connected to the receptacle;
identifying a signature of the push to talk accessory; and
configuring the wireless communication device with push to talk functionality, based on the identified signature of the push to talk accessory.

2. The wireless communication method of claim 1, wherein the push to talk accessory includes a USB connector and the receptacle is a USB port.

3. The wireless communication method of claim 1, wherein the push to talk accessory includes a HDMI connector and the receptacle is a HDMI port.

4. The wireless communication method of claim 1, wherein the push to talk accessory includes a headset connector and the receptacle is a headset jack receptacle.

5. The wireless communication method of claim 1, further comprising providing indicia that the wireless communication device has push to talk functionality.

6. A wireless communication device with push to talk feature, comprising:
a push to talk accessory including a connector configured to be connected to a wireless communication device; and
a wireless communication device including: a housing including a receptacle; a controller coupled to the housing, the controller configured to control the operations of a wireless communication device; and a PTT management module configured to: detect a trigger signal that a push to talk accessory has been connected; identify a signature of a push to talk accessory; and configure the wireless communication device with push to talk functionality, based on the identified signature of the push to talk accessory.

7. The wireless communication device of claim 6, wherein the push to talk accessory includes at least one of a USB connector, a HDMI connector and a headset connector and the receptacle includes at least one of a USB port, a HDMI port and a headset jack receptacle, respectively, the receptacle being complementarily configured to be receive the connector.

8. The wireless communication device of claim 6, further comprising a user interface including a display providing indicia confirming that the wireless communication device has push to talk functionality that is enabled.

9. The wireless communication device of claim 6, wherein the push to talk device includes indicia that push to talk functionality is enabled.

10. A wireless communication method with push to talk feature, comprising:
providing a wireless communication device including a receptacle for attaching a PTT button;
providing a PTT application with a configuration option;
allowing the user to configure the application to respond to a PTT button attached to the receptacle; and
configuring the wireless communication device with push to talk functionality using the attachable button, based on a configuration setting.

11. A push to talk module including:
a housing having an aperture;
a button module including a button reachable through the aperture;
a printed circuit including a switch;
a plug connected to the printed circuit; and
a base with a hole, the hole configured to receive the plug.

12. The push to talk module of claim 11, wherein the housing includes a first layer, the button a second layer, the printed circuit and plug a third layer and the base a fourth layer, defining a multilayered structure.

13. The push to talk module of claim 11, wherein the housing defines an upper portion and the base a bottom portion, defining a narrow profile structure.

14. The push to talk module of claim 11, wherein the button includes an LED.

15. The push to talk module of claim 11, further comprising a second connector.

16. The push to talk module of claim 11, wherein the push to talk module is integrated in a protective structure.

17. The push to talk module of claim 11, wherein the button includes a receptacle to allow a charger to be connected.

18. The push to talk module of claim 11, wherein the plug includes at least one of a USB connector, a HDMI connector and a headset connector.

19. The push to talk module of claim 11, wherein the push to talk module is passive.

20. The push to talk module of claim 11, wherein the push to talk module is integrated into an external accessory.
